(19) United States
(12) Patent Application Publication
(10) Pub. No.: US 2022/0215979 A1
(43) Pub. Date: Jul. 7, 2022

(54) METHOD AND SYSTEM FOR PRODUCING MEDICAL RADIOISOTOPES

(71) Applicant: KOREA ADVANCED INSTITUTE OF SCIENCE AND TECHNOLOGY, Daejeon (KR)

(72) Inventors: Yonghee KIM, Daejeon (KR); Kwangho JU, Daejeon (KR); Seongdong JANG, Daejeon (KR)

(21) Appl. No.: 17/366,116

(22) Filed: Jul. 2, 2021

(30) Foreign Application Priority Data
Jan. 5, 2021 (KR) 10-2021-0000631

(51) Int. Cl. G21G 1/00; G21G 1/10

(52) U.S. Cl. CPC G21G 1/001; G21G 2001/0094; G21G 2001/0089; G21G 1/10

(57) ABSTRACT

The invention relates to a method and a system for producing radioisotopes, and specifically, the method and system for producing radioisotopes including generating one or more among actinium-225 (²²⁵Ac), thorium-227 (²²⁷Th), and radium-226 (²²⁶Ra) by irradiating a natural thorium target including thorium-232 (²³²Th) with braking radiation or an accelerated electron beam.

### CROSS-REFERENCES TO RELATED APPLICATION

This patent application claims the benefit of priority from Korean Patent Application No. 10-2021-0000631, filed on Jan. 5, 2021, the contents of which are incorporated herein by reference.

### BACKGROUND OF THE INVENTION

### 1. Field of the Invention

The present disclosure relates to a method and a system for producing medical radioisotopes, and more specifically, to a method and a system for producing one or more among actinium-225 (²²⁵Ac), thorium-227 (²²⁷Th), and radium-226 (²²⁶Ra), which are radioisotopes used for a targeted alpha therapy (TAT), by irradiating a natural thorium target with braking radiation or an accelerated electron beam.

### 2. Description of the Related Art

With the recent advancement in medical imaging-related technologies as well as the rapid development in molecular biology, cell biology, and genetic engineering, cancer cells can be more accurately specified, and thus, targeted radionuclide therapy (TRT) is in the spotlight. TRT is a method in which a cancer cell-friendly compound is labeled with a radionuclide and administered to a cancer patient, and the radiolabeled compound gathers into cancer cells by a biokinetic process, where the labeled radionuclide decays and emits radiation which kills the cancer cells.

Radiation emitted from medical radioisotopes is classified into radiation for a diagnostic purpose and for a therapeutic purpose depending on the type thereof. Gamma rays are mainly used for the diagnostic purpose, and alpha rays (bismuth-212, astatine-211, actinium-225) and beta rays (iodine-131, yttrium-90) are for the therapeutic purpose. When considering the physical properties of each radiation, methods using the alpha rays are more effective than those using the beta rays in cancer treatment. Energy of the alpha rays emitted during alpha decay is mostly 5-9 MeV, which is higher than that of the beta rays. However, the range in tissues of the alpha rays is about 50-90 p m long, which corresponds to the length of 2-10 cells, and is much shorter than that of the beta particles, which is 500-12000 p m long. In other words, the linear energy transfer (LET) of the alpha particles is 60-230 keV/p m, which is tens of times greater than that of the beta particles, which is 0.1-1 keV/p m. If an alpha nuclide is targeted to a cancer cell, it is possible to deliver more energy per unit length only to the cancer cell according to the definition of the LET. Based on these characteristics, the need for an alpha-emitting medical isotope capable of delivering greater energy only to cancer cells, thereby minimizing side effects of treatment, while minimizing damage to peripheral normal cells has increased. However, when compared to a beta-emitting nuclide, studies related to the production and utilization of an alpha-emitting nuclide have not been actively conducted. This is because not only that production methods of alpha-emitting nuclide are complicated but also that the production volume thereof is small, and thus, the unit cost thereof is too high to supply sufficient amount of alpha-emitting nuclides for use in clinical research.

Among isotopes emitting alpha rays such as bismuth-212, astatine-211, thorium-227, and actinium-225, may be used for a therapeutic purpose, but the most ideal isotope is actinium-225 from multiple perspectives. First of all, actinium-225 has a long half-life of 10 days compared to other nuclides, and thus, is more advantageous in terms of production and use than astatine-211 (half-life: 7.2 hours) and bismuth-212 (half-life: 1 hour). In addition, actinium-225 does not emit energetic gamma rays and thus, is suitable for studying effects of nuclides on biological metabolism. Lastly, when actinium-225 decays, a total of four alpha rays are emitted due to the successive decay of daughter nuclides, so that sufficient energy can be delivered to cancer cells compared to other alpha-emitting nuclides. Thorium-227 also has a long half-life of 18.7 days and emits a total of 5 alpha rays through successive decay, and thus, is capable of effectively removing cancer cells when used for a TAT. As a related art, Korean Patent Laid-Open Publication No. 10-2003-0029100 discloses a radiation therapy method using thorium-227 or actinium-225 which release alpha particles. In fact, when a TAT using actinium-225 was performed on patients with advanced prostate cancer at Heidelberg University Hospital in Germany in 2016, tumors were completely disappeared and no side effects were observed.

Meanwhile, actinium-225 was first produced in 2000 by a method in which radium-226 is bombarded with deuterium ions accelerated to 20-30 MeV. However, the annual production volume thereof was initially about 600 mCi, which fell far short of the demand at the time, which was about 7500 mCi, and the price thereof was very high, which was $1,200 per mCi. Therefore, various ways of utilizing nuclear reactors and accelerators to produce actinium-225 have been discussed (Nucl Med Mol Catalysis Vol. 41, No. 1, February 2007). However, as of 2020, the only commercially available production method is extracting actinium-225 using uranium-233 produced through a molten salt nuclear reactor program at Oak Ridge National Laboratory (ORNL) in the 1960s by the Department Of Energy (DOE) of USA. As of 2019, the production volume of actinium-225 was 63 GBq (=1,703 mCi), which was about three times higher than in the past. However, compared to the projected demand of 1850 GBq (=50,000 mCi), the production volume thereof is still far from sufficient, and the above demand is expected to increase even more in the future with TRT being in the spotlight. In addition, the above-described method can be limitedly adopted only in countries with enriched uranium-233 or thorium-229 (daughter nuclide of uranium-233) and is not unavailable domestically.

As an alternative, target materials such as thorium-232 and radium-226 can be irradiated to produce thorium-229 in a nuclear reactor where thorium-232(n,g)thorium-233 and radium-226(3n,g) radium-229 reactions are used respectively. However, the former takes a long time to produce thorium-229 due to a long half-life of parent nuclide (=160,000 years), and the latter has a small reaction cross-section, so that both methods have a small production volume of thorium-229.

Among methods using an accelerator, the Institute for Transuranium Elements (ITU) of Germany has obtained the most meaningful results by irradiating proton beam to cause a radium-226(p,2n) actinium-225 reaction to occur. While the prior method obtained actinium-225 from the natural decay of thorium-229, the method adopted in ITU is advantageous in that it is possible to immediately obtain actinium-225. In 2005, the ITU produced about 13 mCi of actinium-225 by irradiating a specially-prepared RaCl₂ target with 50 μA proton beam of 24.8 MeV for 45.3 hours.

Since then, efforts have been made to increase the production volume by increasing the intensity of the proton beam and optimizing the shape of RaCl₂ target. However, this method also has a number of disadvantages. First, the LET of proton beam is 10.5 keV/p m, which is very large and easy to lose the proton's energy very quickly within a target. However, since the size of an energy region with a large cross-section of the (p,2n) reaction is about 9 MeV, the thickness of the target is bound to be limited to a maximum of 0.76 mm. Even if a target is prepared thin and wide in order to solve the problem, the spatial distribution of typical proton beam limits the size of the target to a similar level of several millimeters, so that the production volume of actinium-225 is bound to be limited. Second, radium-226 is an isotope with a very small annual production volume, which is less than 1 g, and decays into gaseous radium-222 by alpha decay with a half-life of about 1600 years, so that it is very difficult to handle. Therefore, comparing with other methods, a more complex process is required not only for the manufacturing of RaCl₂ target but also for the separation of actinium-225 from radium-226 after beam irradiation.

Meanwhile, a method using weakly radioactive thorium-232 target has also tried by many laboratories to induce thorium-232(p,xn) actinium-225 reaction, but proton beam with a very high energy of 65 MeV or greater is required. Also, various unwanted fissile isotopes such as uranium-235 and plutonium-239 are generated, making a reprocessing process difficult, and in particular, actinium-227, which is difficult to be chemically separated due to the same atomic number as actinium-225, is generated by about 0.3%. The half-life of actinium-227 is about 22 years, and thus, may remain in a human body even after a therapy is finished, causing the human body to be continuously exposed to radiation. Although there was no problem when extracted actinium was injected into a mouse, it is still too early to conclude that it is not dangerous considering the half-life of a nuclide and the life expectancy of a human being.

In addition, a method using braking radiation generated by an accelerated electron beam generator was also tried at the NWS University of Australia in 2007. It extracts actinium-225 from the natural decay of radium-225 generated by radium-226(g, n) radium-225 reaction. The electron beam was irradiated with 26 p A for 2.9 hours to produce 0.029 mCi of actinium-225. The production rate was 0.247 mCi(²²⁵Ac)/g(²²⁶Ra)/h, which was significantly lower, being at a level of 2.6%, compared to the production rate of a proton accelerator, 9.607 mCi(²²⁵Ac)/g(²²⁶Ra)/h. If it is possible to irradiate a large amount of target materials with gamma rays to increase the production volume of actinium-225, it is sufficiently competitive in terms of economic feasibility. However, as described above, radium-226 is highly radioactive and has low annual production volume, so that it still remains problematic to handle the large volume of radium-226.

Thorium-227 is generated by the natural decay of actinium-227, which is a sole isotope with extremely small volume in nature and is produced by sequential decay of uranium-235. Therefore, in general, radium-226 is irradiated with a neutron to produce actinium-227 in large quantities, and then thorium-227 is extracted therefrom. However, as described above, radium is an isotope whose production volume is small and which is difficult to handle. Even a method of utilizing a proton accelerator, which is an alternative to an existing production method, may also generate various unwanted fissile elements.

Therefore, the applicant has developed a method and a system for producing radioisotopes by using a natural thorium target, which has low radioactivity and easily used in many countries. The method and system can generate one or more actinium-225 (²²⁵Ac), thorium-227 (²²⁷Th), and radium-226 (²²⁶Ra), which is used in the research to produce medical isotopes with an accelerator, by utilizing a photonuclear reaction after photo-absorption in multiple steps, and has completed the present invention.

### PRIOR ART DOCUMENT

### Patent Document

Korean Patent Laid-Open Publication No. 10-2003-0029100 (published on Apr. 11, 2003)

### Non-Patent Document

Applied Radiation and Isotopes 62 (2005) 383-387
Nucl Med Mol Imaging Vol 41, No 1, February 2007

### SUMMARY OF THE INVENTION

One object of the present invention is to provide a method and a system for producing radioisotopes.

In order to achieve the object, the present invention provides a method for producing radioisotopes, the method including generating one or more among actinium-225 (²²⁵Ac), thorium-227 (²²⁷Th), and radium-226 (²²⁶Ra) by irradiating a natural thorium target including thorium-232 (²³²Th) with braking radiation or an accelerated electron beam.

The present invention also provides a system for producing radioisotopes, the system generating one or more among actinium-225 (²²⁵Ac), thorium-227 (²²⁷Th), and radium-226 (²²⁶Ra), and including a generation unit for generating a braking radiation or accelerated electron beam, and an irradiation unit for irradiating a natural thorium target including thorium-232 (²³²Th) with braking radiation or an accelerated electron beam generated from the generation unit.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a drawing illustrating, when a natural thorium target including thorium-232 (²³²Th) is irradiated with braking radiation, a photonuclear reaction occurring in the target and a decay scheme of generated nuclides;

FIG. 2 is a process flow diagram sequentially illustrating a method for producing radioisotopes according to one aspect;

FIG. 3 is a schematic view schematically illustrating a system for producing radioisotopes according to another aspect;

FIG. 4 and FIG. 5 are schematic views schematically illustrating a cross-section of an irradiation unit of a system for producing radioisotopes according to another aspect;

FIG. 6 is a graph illustrating the change in the number density of thorium isotopes and actinium isotopes included in a target over time elapsed from the irradiation of the target in a method for producing radioisotopes according to one aspect;

FIG. 7 is a graph illustrating the production volume of actinium-225 (²²⁵Ac) according to the irradiation time and extraction period of an electron beam in a method for producing radioisotopes according to one aspect;

FIG. 8 is a graph illustrating the number density of radioisotopes included in impurities over time after subjecting a target to primary cooling and separating the thorium isotopes and impurities through chemical treatment in a method for producing radioisotopes according to one aspect; and

FIG. 9 is a graph illustrating the production volume of thorium-227 (²²⁷Th) according to the irradiation time of an electron beam and extraction period of thorium-227 in a method for producing radioisotopes according to one aspect.

### DESCRIPTION OF THE PREFERRED EMBODIMENTS

Hereinafter, preferred embodiments of the present invention will be described with reference to the accompanying drawings. However, embodiments of the present invention may be modified into other various forms, and the scope of the present invention is not limited to the embodiments described below. In addition, the following embodiments are provided in order to more fully describe the present invention to those with average knowledge in the art. Therefore, the shapes and sizes of elements in the drawings may be exaggerated for clearer explanation, and elements indicated by the same reference numerals in the drawings are the same elements. In addition, for parts serving similar functions and actions, the same reference numerals are used throughout the drawings. Furthermore, throughout the specification, when a portion is said to “include” any component, it means that the portion may further include other components rather than excluding the other components unless otherwise stated.

In one aspect, the present invention provides a method for producing radioisotopes, the method including producing one or more among actinium-225 (²²⁵Ac), thorium-227 (²²⁷Th), and radium-226 (²²⁶Ra) by irradiating a natural thorium target including thorium-232 (²³²Th) with braking radiation or an accelerated electron beam.

Hereinafter, the method for producing radioisotopes according to one aspect will be described in detail with reference to the accompanying drawings.

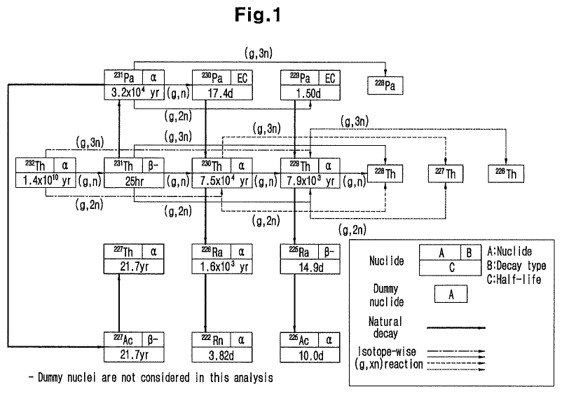

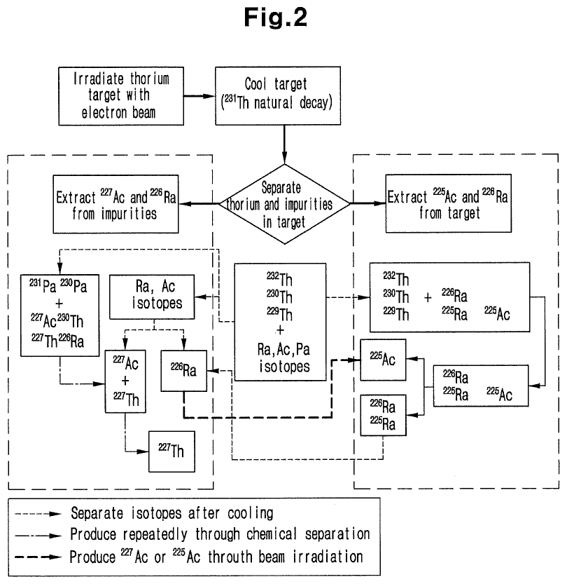

FIG. 1 is a drawing illustrating, when a natural thorium target including thorium-232 (²³²Th) is irradiated with braking radiation or an accelerated electron beam, a photonuclear reaction occurring in the target and a decay scheme of generated nuclides, and FIG. 2 is a process flow diagram sequentially illustrating a method for producing radioisotopes according to one aspect.

At this time, the natural thorium target may include thorium-232 (²³²Th) in an amount equal to or greater than 99 wt %, preferably equal to or greater than 99.98 wt %, and may also include thorium-230 (²³⁰Th) in an amount less than 0.02 wt %.

The natural thorium target may be received inside shielding and cooling equipment for cooling and shielding. At this time, the shielding and cooling equipment may be cooled by a coolant, and the coolant may preferably be water, which has a high heat removal efficiency and an excellent neutron moderation effect. A neutron moderated by the coolant may be shielded by reacting with a material having a high absorption cross-section among materials constituting the shielding and cooling equipment.

In addition, the natural thorium target may be prepared in various sizes and shapes.

For example, the target may be prepared in a cylindrical shape having a radius of 60 mm to 100 mm and a height of 10 mm to 40 mm. Preferably, the target may be received in the shielding and cooling equipment in a rotatable shape to lower the heat density of the target, thereby increasing the stability of phase change caused by the braking radiation or electron beam irradiated for a long time.

In addition, as a method for irradiating the natural thorium target with braking radiation or an accelerated electron beam, a method may be performed wherein the accelerated electron beam or the like is irradiated on a separate target (second target) to generate braking radiation from the target (second target) and then the generated braking radiation is irradiated on a natural thorium target (first target). However, preferably, since the natural thorium target itself has a high atomic number and a high melting point, and thus, has a high braking radiation generation efficiency, in order to simplify a system and maximize the production volume of thorium-229 (²²⁹Th), a method may be performed wherein the accelerated electron beam is directly irradiated on a natural thorium target (first target) to generate braking radiation, and then the generated braking radiation is irradiated on the natural thorium target.

In the method for producing radioisotopes according to an embodiment, the generating of one or more among actinium-225 (²²⁵Ac), thorium-227 (²²⁷Th), and radium-226 (²²⁶Ra) includes generating actinium-225 (²²⁵Ac), wherein the generating of actinium-225 (²²⁵Ac) includes generating thorium isotopes including thorium-229 (²²⁹Th) by irradiating the natural thorium target including thorium-232 (²³²Th) with the braking radiation or an accelerated electron beam, and generating actinium-225 (²²⁵Ac) by the decay of the thorium-229 (²²⁹Th).

Referring to FIG. 2, the generating of actinium-225 (²²⁵Ac) may be periodically generating actinium-225 (²²⁵Ac) from thorium-229 (²²⁹Th), which is a parent nuclide of actinium-225 (²²⁵Ac), by irradiating the natural thorium target with braking radiation or an accelerated electron beam. Through the above step, actinium-225 (²²⁵Ac) may be generated semi-permanently.

The generating of thorium isotopes including thorium-229 (²²⁹Th) may be generating thorium isotopes including thorium-229 (²²⁹Th) and thorium-230 (²³⁰Th) from thorium-232 (²³²Th) by utilizing a photonuclear reaction, in which one or more neutrons are released by braking radiation or an accelerated electron beam, in multiple steps.

The photonuclear reaction may include a thorium-232 (g,xn) thorium-(232-x) reaction, and may also include a photonuclear reaction of releasing neutrons from thorium isotopes having a mass number other than 232.

At this time, the thorium-232 (g,xn) thorium-(232-x) reaction means a reaction of generating thorium-(232-x) (^{232-x}Th) by releasing x number (xn) of neutrons from thorium-232 (²³²Th) by gamma rays (g).

Therefore, in the above step, for example, thorium-229 (²²⁹Th) may be generated from thorium-232 (²³²Th) through a thorium-232 (g,3n) thorium-229 reaction, or thorium-229 (²²⁹Th) may be generated from thorium-232 (²³²Th) by a two-step photonuclear reaction occurring in a chain and in which thorium-231 (²³¹Th) generated by a thorium-232 (g,n) thorium-231 reaction generates thorium-229 (²²⁹Th) through a thorium-231 (g, 2n) thorium-229 reaction.

In addition, thorium-229 (²²⁹Th) may be generated from thorium-232 (²³²Th) by a three-step photonuclear reaction occurring in a chain and in which thorium-231 (²³¹Th) generated by the thorium-232 (g, n) thorium-231 reaction generates thorium-230 (²³⁰Th) through a thorium-231 (g,n) thorium-230, and then generates thorium-229 (²²⁹Th) from a thorium-230 (g,n) thorium-229 reaction.

Referring to FIG. 1, by irradiating a natural thorium target including thorium-232 (²³²Th) with braking radiation or an accelerated electron beam, the photonuclear reaction in which neutrons are released from thorium-232 (²³²Th) may occur in multiple steps, and through the above, thorium isotopes including thorium-229 (²²⁹Th) and thorium-230 (²³⁰Th) may be generated.

The generating of thorium isotopes including thorium-229 (²²⁹Th) is different from an existing method of naturally decaying uranium-233 (²³³U) to generate thorium-229 (²²⁹Th), and has an advantage of generating thorium-229 (²²⁹Th) without limitation in many countries who cannot handle uranium-233 (²³³U), since thorium-229 (²²⁹Th) is generated from a natural thorium target.

In addition, since thorium-229 (²²⁹Th) is generated by causing a chain photonuclear reaction, wherein the photonuclear reaction in which neutrons are released from thorium isotopes occurs in multiple steps by braking radiation or an accelerated electron beam, it is possible to generate a significantly large amount of thorium-229 (²²⁹Th) compared to a method in which 3(3n) neutrons are released only from thorium-232 by a single photonuclear reaction of thorium-232 (g,3n) thorium-229 to generate thorium-229 (²²⁹Th), and ultimately, there is an advantage of significantly increasing the production volume of actinium-225 (²²⁵Ac) generated therefrom.

At this time, the accelerated electron beam may preferably have an energy of 25 MeV to 50 MeV to generate braking radiation generated by the accelerated electron beam to trigger the chain photonuclear reaction.

If the energy of the accelerated electron beam is less than 25 MeV, the chain photonuclear reaction may not sufficiently occur to produce a meaningful amount of thorium-229 (²²⁹Th), and when the energy of the accelerated electron beam is greater than 50 MeV, the heat density in a target increases, which may cause a soundness problem in shielding and cooling equipment containing the target.

In addition, the accelerated electron beam may have a beam current value of 50 mA to 150 mA, and may preferably have a beam current value of 60 mA to 100 mA.

If the beam current of the accelerated electron beam is less than current 50 mA, a lot of irradiation time may be required to generate the same amount of thorium-229 (²²⁹Th), and when the beam current of the accelerated electron beam is greater than 150 mA, the heat density of a target increases, which may cause a soundness problem in shielding and cooling equipment containing the target.

Meanwhile, the generation efficiency may be linearly proportional to the energy of the electron beam when the current of the electron beam is the same.

The irradiation time of the braking radiation or accelerated electron beam may vary in order to increase the production volume and the usability of actinium-225 (²²⁵Ac). The irradiation time of the braking radiation may be 100 days or more, more preferably 180 days or more, still more preferably 300 days or more, even more preferably 1 year to 10 years, and yet more preferably 1 year to 5 years.

If the irradiation time of the braking radiation or accelerated electron beam is less than 100 days, the amount of thorium-229 (²²⁹Th) generated from the target is small, so that the extraction volume of actinium-225 (²²⁵Ac) may become small. When the irradiation time of the braking radiation is greater than 10 years, the irradiation time of braking radiation, that is, the time during which actinium-225 (²²⁵Ac) cannot be extracted is too long, which may be inefficient in terms of the production of actinium-225 (²²⁵Ac).

Of the content of thorium-232 (²³²Th) contained in the natural thorium target, the amount of thorium-232 (²³²Th) reduced by the chain photonuclear reaction may be only equal to or less than 1 wt % for at least a few decades. Accordingly, the production volume of the thorium-229 (²²⁹Th) and the thorium-230 (²³⁰Th) generated by the photonuclear reaction may be linearly increased in proportion to the irradiation time of the braking radiation, and the decrease in the production volume of thorium (Th) isotopes according to the irradiation time may be insignificant.

Meanwhile, as shown in FIG. 1, by causing the chain photonuclear reaction to occur by irradiating the natural thorium target with the braking radiation or accelerated electron beam, thorium-230 (²³⁰Th) may further be generated in the natural thorium target other than thorium-229 (²²⁹Th), and one or more thorium isotopes selected from the group consisting of thorium-231 (²³¹Th), thorium-228 (²²⁸Th), thorium-227 (²²⁷Th), and thorium-226 (²²⁶Th) may further be generated. Among the thorium (Th) isotopes, thorium-231 (²³¹Th) generates actinium-227 (²²⁷Ac) when naturally decayed.

When actinium-227 (²²⁷Ac) is not removed from the target, actinium-227 (²²⁷Ac) is extracted together with actinium-225 (²²⁵Ac) when actinium-225 (²²⁵Ac) is extracted from the target later, so that it may be difficult to extract actinium-225 (²²⁵Ac) of high purity.

Accordingly, before extracting actinium-225 (²²⁵Ac) from the target, it is preferable to remove thorium-231 (²³¹Th), which is a parent nuclide of actinium-227 (²²⁷Ac), among the thorium (Th) isotopes generated by the chain photonuclear reaction.

To this end, the method for producing radioisotopes may further include, after generating the thorium isotope, subjecting the target to primary cooling to naturally decay and remove thorium-231 (²³¹Th) included in the thorium isotope.

The primary cooling may be performed by stopping the irradiation of the braking radiation or accelerated electron beam and then maintaining the target in the shielding and cooling equipment for a predetermined period of time.

The primary cooling time may preferably be 10 days or more, more preferably 30 days or more, still more preferably 50 days or less, and even more preferably 40 days or less.

Thorium-231 (²³¹Th) included in the target may be naturally decayed by the primary cooling, through which the parent nuclide of actinium-227 (²²⁷Ac) may be removed from the target. Therefore, when extracting actinium-225 (²²⁵Ac), actinium-225 (²²⁵Ac) of higher purity may be extracted.

More specifically, the primary cooling may be performed for 10 days or more to reduce the amount of actinium-227 (²²⁷Ac), which is included when extracting actinium-225 (²²⁵Ac), to 0.25 wt % or less, and the primary cooling may be performed for 30 days or more to reduce the amount of actinium-227 (²²⁷Ac), which is included when extracting actinium-225 (²²⁵Ac), to 4×10⁻⁷% or less.

However, the primary cooling time may vary as the change of energy distribution of braking radiation affected by the energy of an accelerated electron beam.

For example, when considering the conservative annual intake limit of 30 Bq of actinium-227 (²²⁷Ac) set forth in Attached Table 3 of the Standards for Radiation Protection, etc. notified by the Nuclear Safety and Security Commission, the number density of actinium injected into a body should be lower than 98/cm³. When using braking radiation generated with an electron beam of 80 mA, the number density of actinium-227 (²²⁷Ac) in a target may be reduced to 64/cm³ during a 34-day cooling. At this time, the cooling time may preferably be 32 days to 36 days, and may more preferably be 34 days.

In addition, the method for producing radioisotopes may further include, distinguishing and separating a protactinium (Pa) isotope from other radium (Ra) and actinium (Ac) isotopes among radioisotopes except for the thorium isotope from the primarily cooled target, which is performed before extracting the generated actinium-225 (²²⁵Ac).

The target may further include other radioisotopes other than thorium, for example impurities of a natural thorium target itself, products generated during the generation of thorium isotopes including the thorium-229 (²²⁹Th), or products generated during the natural decay process of thorium-231 (²³¹Th).

The other radioisotopes other than thorium may include, for example, actinium (Ac), protactinium (Pa), radium (Ra), and the like. More specifically, they may include one or more among radium-225 (²²⁵Ra), radium-226 (²²⁶Ra), actinium-227 (²²⁷Ac), actinium-225 (²²⁵Ac), protactinium-231 (²³¹Pa), and protactinium-230 (²³⁰Pa).

If the separating of radioisotopes except for the thorium isotope is not performed before the extracting of actinium-225 (²²⁵Ac), other actinium isotopes may be extracted together other than actinium-225 (²²⁵Ac) during the extraction process of actinium-225 (²²⁵Ac), and thus, it may be difficult to extract actinium-225 (²²⁵Ac) of high purity.

In the method for producing radioisotopes according to one aspect, thorium-231 (²³¹Th), which is a parent nuclide of actinium-227 (²²⁷Ac), is removed from a target through the primary cooling, and then other radioisotopes other than thorium (Th) are removed from the target through the removing of radioisotopes other than thorium isotopes, so that the target may be made of thorium isotopes including thorium-232 (²³²Th) and thorium-229 (²²⁹Th) but not including thorium-231 (²³¹Th) and of a radioisotope decayed therefrom.

In addition, the method for producing radioisotopes may further include extracting the generated actinium-225 (²²⁵Ac).

The extracting of actinium-225 (²²⁵Ac) may be performed in a manner in which an actinium isotope is extracted from the target.

More specifically, in order to extract the actinium isotope, a cation and anion resin separation method or a method using a nitric acid solution may be used to chemically separate the actinium isotope from the target.

For example, as the method using a nitric acid solution, ThO₂ is first adsorbed on a titanium phosphate resin, and then nitric acid is flowed thereon to elute actinium and radium isotopes. Thereafter, actinium-225 (²²⁵Ac) may be extracted by a method in which an elution solution is adsorbed on a cation exchange resin, and then a nitric acid solution having a different concentration is flowed on a column to elute and purify an actinium isotope.

The annual production volume of actinium-225 (²²⁵Ac) produced by the above method may be increased as the extraction period of actinium-225 (²²⁵Ac) gets longer within the range of 32 days or less, and may be decreased as the extraction period gets longer within the range of greater than 32 days. Accordingly, the extraction period of actinium-225 (²²⁵Ac) may appropriately be selected within the range of 32 days or less in consideration of the demand of actinium-225 (²²⁵Ac).

At this time, the extraction period of actinium-225 (²²⁵Ac) means a period from the point of time when the target is cooled and then radioisotopes other than thorium isotopes are removed from the target to the point of time when actinium-225 (²²⁵Ac) is extracted.

Meanwhile, in a method for producing radioisotopes according to another embodiment, the generating of one or more among actinium-225 (²²⁵Ac), thorium-227 (²²⁷Th), and radium-226 (²²⁶Ra) includes generating thorium-227 (²²⁷Th), wherein the generating of thorium-227 (²²⁷Th) includes generating thorium isotopes by irradiating the natural thorium target including thorium-232 (²³²Th) with the braking radiation or accelerated electron beam, distinguishing and separating a protactinium (Pa) isotope from other radium (Ra) and actinium (Ac) isotopes among radioisotopes except for the thorium isotope from the target, extracting actinium-227 (²²⁷Ac) from each of the protactinium (Pa) radioisotope and the other radium (Ra) and actinium (Ac) radioisotopes, which have been distinguished and separated from the target, and generating thorium-227 (²²⁷Th) by natural decay of actinium-227 (²²⁷Ac).

Referring to FIG. 2, the generating of thorium-227 (²²⁷Th) may be a step in which the natural thorium target is irradiated with braking radiation or an accelerated electron beam, and then thorium-227 (²²⁷Th) is generated from one or more among actinium-227 (²²⁷Ac), which is a parent nuclide of thorium-227 (²²⁷Th), and protactinium-231 (²³¹Pa) among radioisotopes separated from the target. Particularly, actinium-227 (²²⁷Ac) may be periodically generated from protactinium-231 (²³¹Pa), and through the above, thorium-227 (²²⁷Th) may be semi-permanently generated.

Actinium-227 (²²⁷Ac) is the only actinium isotope that exists in nature, but only an extremely small amount thereof is produced during the decay uranium-235 (²³⁵U). Therefore, in general, a method is used in which radium-226 (²²⁶Ra) is irradiated with a neutron to produce actinium-227 (²²⁷Ac) in large quantities, and then thorium-227 (²²⁷Th) is extracted therefrom. However, radium is an isotope whose production volume is small and which is difficult to handle. Even a method of utilizing a proton accelerator, which is an alternative to an existing production method, may also cause various unwanted fissile elements to be generated.

On the other hand, the generating of thorium-227 (²²⁷Th) generates actinium-227 (²²⁷Ac) and protactinium-231 (²³¹Pa) by irradiating a natural thorium with braking radiation or an accelerated electron beam, and thus, has an advantage of generating thorium-227 (²²⁷Th) more easily.

The generating of thorium isotopes may be generating thorium isotopes from thorium-232 (²³²Th) by utilizing a photonuclear reaction, in which one or more neutrons are released by braking radiation or an accelerated electron beam, in multiple steps.

The thorium isotope generated at this time may include one or more among thorium-229 (²²⁹Th) and thorium-230 (²³⁰Th), and may further include one or more selected from the group consisting of thorium-231 (²³¹Th), thorium-228 (²²⁸Th), thorium-227 (²²⁷Th), and thorium-226 (²²⁶Th).

The generating of thorium-227 (²²⁷Th) may further include, before distinguishing and separating a protactinium (Pa) isotope from other radium (Ra) and actinium (Ac) isotopes among radioisotopes except for the thorium isotope from the target, subjecting the target to primary cooling to naturally decay and remove thorium-231 (²³¹Th) included in the thorium isotope.

As other radioisotopes other than thorium, generated by decay of thorium isotopes generated by the irradiation of the braking radiation or accelerated electron beam may include actinium (Ac), protactinium (Pa), radium (Ra), and the like. More specifically, one or more among radium-225 (²²⁵Ra), radium-226 (²²⁶Ra), actinium-225 (²²⁵Ac), actinium-227 (²²⁷Ac), protactinium-231 (²³¹Pa), and protactinium-230 (²³⁰Pa) may be decayed and included.

Therefore, radioisotopes separated from the target may include one or more among radium-225 (²²⁵Ra), radium-226 (²²⁶Ra), actinium-225 (²²⁵Ac), actinium-227 (²²⁷Ac), protactinium-231 (²³¹Pa), and protactinium-230 (²³⁰Pa), and among the protactinium (Pa) isotopes, protactinium-230 (²³⁰Pa) generated thorium-230 (²³⁰Th) when naturally decayed.

When protactinium-230 (²³⁰Pa), which is a parent nuclide of thorium-230 (²³⁰Th), is not removed from the separated radioisotopes, thorium-230 (²³0Th) is extracted together with thorium-227 (²²⁷Th) when thorium-227 (²²7Th) is extracted from the separated radioisotopes later, so that it may be difficult to extract thorium-227 (²²7Th) of high purity.

Accordingly, before extracting thorium-227 (²²⁷Th) from the separated radioisotopes, it is preferable to distinguish and separate protactinium (Pa) isotopes including protactinium-230 (²³⁰Pa), which is a parent nuclide of thorium-230 (²³⁰Th), from radium (Ra) and actinium (Ac) isotopes contained in impurities.

In order to extract thorium-227 (²²⁷Th) of high purity, in the method for producing radioisotopes, during a process of separating and removing radioisotopes except for the thorium isotope from the primarily cooled target, protactinium (Pa) isotopes may be separated and removed from other radium (Ra) and actinium (Ac) isotopes.

Among the separated protactinium (Pa) isotopes which have been separated and removed from the radium (Ra) and actinium (Ac) isotopes, protactinium-231 (²³¹Pa) naturally decays and generates actinium-227 (²²⁷Ac). Therefore, actinium-227 (²²⁷Ac) may be periodically extracted from the separated protactinium (Pa) isotopes, and through the above, actinium-227 (²²⁷Ac) may be semi-permanently generated.

The radium (Ra) and actinium (Ac) isotopes separated from the target may include one or more among actinium-225 (²²⁵Ac), radium-225 (²²⁵Ra), and radium-226 (²²⁶Ra) other than actinium-227 (²²⁷Ac).

The distinguishing and separating of a protactinium (Pa) isotope from other radium (Ra) and actinium (Ac) isotopes among radioisotopes except for the thorium isotope from the target may be performed by a chemical separation method.

The radium (Ra) and actinium (Ac) radioisotopes separated from the target through a chemical separation process do not include or include an extremely small amount of thorium isotopes except for thorium-227 (²²⁷Th) generated during the natural decay of actinium-227 (²²⁷Th), so that thorium-227 (²²⁷Th) may be easily extracted from actinium-227 (²²⁷Ac) and protactinium-231 (²³¹Pa) later.

The method for producing radioisotopes may further include extracting the generated thorium-227 (²²⁷Th).

In order to extract thorium isotopes, the generating of thorium-227 (²²⁷Th) may be performed by a method in which a cation and anion resin separation method or a method using a nitric acid solution is used to chemically separate the thorium isotope from the separated radioisotopes.

In a method for producing radioisotopes according to still another embodiment, the generating of one or more among actinium-225 (²²⁵Ac), thorium-227 (²²⁷Th), and radium-226 (²²⁶Ra) may include generating radium-226 (²²⁶Ra).

The method for producing radioisotopes may generate radium-226 (²²⁶Ra) from a natural thorium target through the above step, and the generated radium-226 (²²⁶Ra) may be used for generating actinium-225 (²²⁵Ac), thorium-227 (²²7Th), and the like. For example, by a method of irradiating radium-226 (²²⁶Ra) with one or more among braking radiation, an accelerated electron beam, neutrons, and protons, one or more among actinium-225 (²²⁵Ac) and thorium-227 (²²⁷Th) may be generated.

The generating of radium-226 (²²⁶Ra) according to an embodiment may include generating thorium isotopes including thorium-230 (²³⁰Th) by irradiating the natural thorium target including thorium-232 (²³²Th) with the braking radiation or accelerated electron beam, and generating radium-226 (²²⁶Ra) by the decay of the thorium-230 (²³⁰Th).

Referring to FIG. 2, the generating of radium-226 (²²⁶Ra) may be periodically generating radium-226 (²²⁶Ra) from thorium-230 (²³⁰Th) by irradiating a natural thorium target with the braking radiation or accelerated electron beam, thereby generating thorium-230 (²³⁰Th), which is a parent nuclide of radium-226 (²²⁶Ra). Through the above step, radium-226 (²²⁶Ra) may be generated semi-permanently.

The generating of thorium isotopes including thorium-230 (²³⁰Th) may be generating thorium isotopes including thorium-230 (²³⁰Th) from thorium-232 (²³²Th) by utilizing a photonuclear reaction, in which one or more neutrons are released by braking radiation or an accelerated electron beam, in multiple steps.

The thorium isotope generated at this time may further include thorium-229 (²²⁹Th), and may further include one or more selected from the group consisting of thorium-231 (²³¹Th), thorium-228 (²²⁸Th), thorium-227 (²²⁷Th), and thorium-226 (²²⁶Th).

Referring to FIG. 2, after the irradiation of the braking radiation or accelerated electron beam, the target may include actinium (Ac), protactinium (Pa), radium (Ra), and the like, which are decayed from the thorium isotope. More specifically, one or more among radium-225 (²²⁵Ra), radium-226 (²²⁶Ra), actinium-225 (²²⁵Ac), actinium-227 (²²⁷Ac), protactinium-231 (²³¹Pa), and protactinium-230 (²³⁰Pa) may be decayed and included.

The method for producing radioisotopes may further include extracting radium-226 (²²⁶Ra).

In addition, before performing the extracting of radium-226 (²²⁶Ra), subjecting the target to primary cooling to naturally decay and remove thorium-231 (²³¹Th) included in the thorium isotope may be further included.

In addition, separating radioisotopes except for the thorium isotope from the primarily cooled target may be further included, which is performed before extracting the generated radium-226 (²²⁶Ra).

Meanwhile, the target may include, as a radium isotope, radium-225 (²²⁵Ra) decayed from thorium-229 (²²⁹Th) and radium-226 (²²⁶Ra) decayed from thorium-230 (²³⁰Th) may be included. When radium-225 (²²⁵Ra) is not removed from the target, radium-225 (²²⁵Ra) is extracted together when radium-226 (²²⁶Ra) is extracted from the target later, so that it may be difficult to extract radium-226 (²²⁶Ra) of high purity.

Therefore, it is preferable to remove radium-225 (²²⁵Ra) before extracting radium-226 (²²⁶Ra) from the target.

To this end, the method for producing radioisotopes may further include, after extracting a radium isotope from the thorium target, subjecting the extracted radium isotope to secondary cooling to naturally decay and remove radium-225 (²²⁵Ra).

The secondary cooling may be performed by maintaining the target for a predetermined period of time such that radium-225 (²²⁵Ra) is naturally decayed.

Generating radium-226 (²²⁶Ra) according to another embodiment may include generating thorium isotopes by irradiating the natural thorium target including thorium-232 (²³²Th) with the braking radiation or accelerated electron beam, distinguishing and separating a protactinium (Pa) isotope from other radium (Ra) and actinium (Ac) isotopes among radioisotopes except for the thorium isotope from the target, and generating radium-226 (²²⁶Ra) from the radium (Ra) and actinium (Ac) isotopes separated from the target.

Referring to FIG. 2, the generating of radium-226 (²²⁶Ra) may be irradiating the natural thorium target with braking radiation or an accelerated electron beam, and then generating radium-226 (²²⁶Ra) from radium (Ra) and actinium (Ac) radioisotopes separated from the target.

The generating of thorium isotopes including thorium-229 (²²⁹Th) may be generating thorium isotopes including thorium-229 (²²⁹Th) from thorium-232 (²³²Th) by utilizing a photonuclear reaction, in which one or more neutrons are released by braking radiation or an accelerated electron beam, in multiple steps.

The thorium isotope generated at this time may further include thorium-230 (²³⁰Th), and may further include one or more selected from the group consisting of thorium-231 (²³¹Th), thorium-228 (²²⁸Th), thorium-227 (²²⁷Th), and thorium-226 (²²⁶Th).

The generating of radium-226 (²²⁶Ra) may further include, before separating radioisotopes except for the thorium isotope from the target, subjecting the target to primary cooling to naturally decay and remove thorium-231 (²³¹Th) included in the thorium isotope.

Meanwhile, as other radioisotopes other than thorium generated by decay of thorium isotopes generated by the irradiation of the braking radiation or accelerated electron beam, may include actinium (Ac), protactinium (Pa), radium (Ra), and the like. More specifically, one or more among radium-225 (²²⁵Ra), radium-226 (²²⁶Ra), actinium-225 (²²⁵Ac), actinium-227 (²²⁷Ac), protactinium-231 (²³¹Pa), and protactinium-230 (²³0Pa) may be decayed and included.

Accordingly, the radioisotopes separated from the target may include one or more among radium-225 (²²⁵Ra), radium-226 (²²⁶Ra), actinium-225 (²²⁵Ac), actinium-227 (²²⁷Ac), protactinium-231 (²³¹Pa), and protactinium-230 (²³⁰Pa).

The method for producing radioisotopes may further include extracting radium-226 (²²⁶Ra), and may further include, before extracting radium-226 (²²⁶Ra), subjecting the radium (Ra) and actinium (Ac) isotopes separated from the target to tertiary cooling to naturally decay and remove radium-225 (²²⁵Ra) included in the separated radioisotopes.

The tertiary cooling may be performed by maintaining the separated radioisotopes for a predetermined period of time such that radium-225 (²²⁵Ra) is naturally decayed.

Meanwhile, according to another aspect, there is provided a system 100 for producing radioisotopes, the system generating one or more among actinium-225 (²²⁵Ac), thorium-227 (²²⁷Th), and radium-226 (²²⁶Ra), and including, a generation unit 110 for generating a braking radiation or accelerated electron beam, and an irradiation unit 120 for irradiating a natural thorium target including thorium-232 (²³²Th) with braking radiation or an accelerated electron beam generated from the generation unit 110.

Hereinafter, the system 100 for producing radioisotopes according to an embodiment will be described in detail with reference to the accompanying drawings.

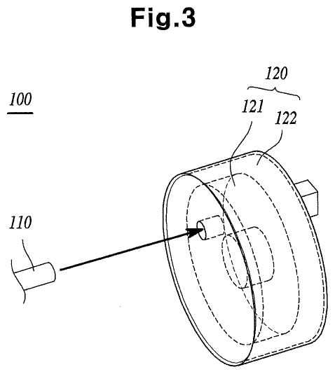

FIG. 3 is a view schematically illustrating the system 100 for producing radioisotopes.

The system 100 for producing radioisotopes may be a device for performing the above-described method for producing radioisotopes.

The generation unit 110 is a component for generating braking radiation irradiated to the irradiation unit 120, and more specifically, may be a component for generating braking radiation for generating thorium isotopes including thorium-229 (²²⁹Th) from thorium-232 (²³²Th) by causing a chain photonuclear reaction to occur.

The generation unit 110 may be a braking radiation generator for generating braking radiation by irradiating a specific target, preferably a target such as tungsten having a high atomic number and a high melting point, with an accelerated electron beam and the like.

Accordingly, the braking radiation generator may generate braking radiation by irradiating a separate target (second target) with an accelerated electron beam and the like. Preferably, since a thorium target itself has a high atomic number and a high melting point, and thus, has a high braking radiation generation efficiency, in order to simplify a system and maximize the production volume of thorium-229 (²²⁹Th), the accelerated electron beam and the like may be directly irradiated on a thorium target (first target) to generate braking radiation.

In addition, the generation unit 110 may be an accelerated electron beam generator for generating an accelerated electron beam to be irradiated on the target such that the target is irradiated with braking radiation causing the chain photonuclear reaction to occur.

In order to simplify the system, it is preferable that the generation unit 110 is the accelerated electron beam generator.

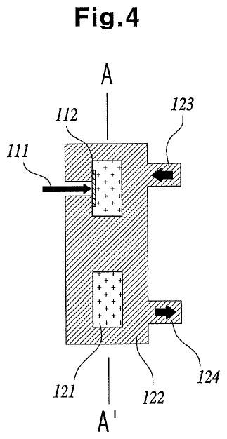

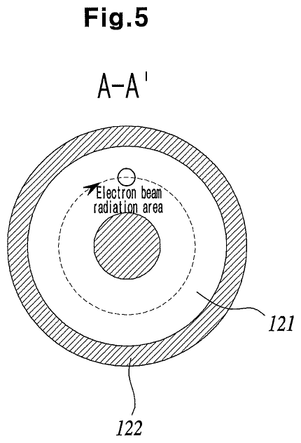

FIG. 4 is a schematic view schematically illustrating a cross-section of the irradiation unit 120 of the system 100 for producing radioisotopes, and FIG. 5 is a schematic view illustrating A-A′ cross-section of the irradiation unit 120 of FIG. 4.

Referring to FIGS. 4 and 5, the irradiation unit 120 may include a natural thorium target 121 including thorium-232 (²³²Th), and shielding and cooling equipment 122 receiving the natural thorium target 121 and cooling and shielding the natural thorium target 121.

The irradiation unit 120 is a component for irradiating a target including thorium-232 (²³²Th) with the braking radiation, and may include the natural thorium target 121 and the shielding and cooling equipment 122.

The natural thorium target 121 may include thorium-232 (²³²Th) in 90% or higher, preferably 99% or higher, and may be prepared in various sizes and shapes.

For example, the natural thorium target 121 may be prepared in a cylindrical shape having a radius of 60 mm to 100 mm and a height of 10 mm to 40 mm.

In addition, as shown in FIG. 5, the natural thorium target 121 may be rotatably received inside the shielding and cooling equipment 122 in order to lower the heat density of the target caused by the irradiation of braking radiation, and through the shape, the stability of phase change caused by the braking radiation irradiated for a long time may be increased.

In addition, the natural thorium target 121 may be received inside the shielding and cooling equipment 122 to be cooled and shielded, and accordingly, the shielding and cooling equipment 122 may preferably further include a cooling unit for cooling the natural thorium target 121 and the shielding and cooling equipment 122.

The irradiation unit 120 may further include a coolant supplying unit for supplying a coolant to the shielding and cooling equipment 122, more preferably to the cooling unit of the shielding and cooling equipment 122. The coolant may be supplied to the shielding and cooling equipment 122 through a coolant inlet 123 of the shielding and cooling equipment 122 and be discharged through a coolant outlet 124.

At this time, as the coolant, water may preferably be used, which has a high heat removal efficiency and an excellent neutron moderation effect. A neutron moderated by the coolant may be shielded by reacting with a material having a high absorption cross-section among materials constituting the shielding and cooling equipment 122.

The system 100 for producing radioisotopes may generate thorium isotopes including thorium-229 (²²⁹Th) from thorium-232 (²³²Th) by causing the chain photonuclear reaction to occur in the natural thorium target 121 by the braking radiation or accelerated electron beam, and may generate actinium-225 (²²⁵Ac) by the decay of thorium-229 (²²⁹Th).

At this time, one or more thorium isotopes selected from the group consisting of thorium-231 (²³¹Th), thorium-230 (²³⁰Th), thorium-228 (²²⁸Th), thorium-227 (²²⁷Th), and thorium-226 (²²⁶Th) may further be generated by the chain photonuclear reaction other than thorium-229 (²²⁹Th).

Among the thorium isotopes, thorium-231 (²³¹Th) generates actinium-227 (²²⁷Ac) when naturally decayed.

If actinium-227 (²²⁷Ac) is not removed from the target when extracting actinium-225 (²²⁵Ac), actinium-225 (²²⁵Ac) and actinium-227 (²²⁷Ac) may be extracted together from the target later, so that it may be difficult to extract actinium-225 (²²⁵Ac) of high purity.

Therefore, in order to extract actinium-225 (²²⁵Ac) of high purity in the following process, the system 100 for producing radioisotopes may irradiate the natural thorium target 121 with braking radiation or an accelerated electron beam, and then subject the target 121 to primary cooling by the shielding and cooling equipment 122 for shielding and cooling to naturally decay and remove thorium-231 (²³¹Th).

The system 100 for producing radioisotopes may further include a separation and recovery unit for distinguishing and separating and recovering a protactinium (Pa) isotope from other radium (Ra) and actinium (Ac) isotopes among radioisotopes except for the thorium isotope from the target 121.

The thorium target 121 from which other radioisotopes other than thorium are removed by the separation and recovery unit may include actinium-225 (²²⁵Ac) generated by the natural decay of thorium-229 (²²⁹Th), or may extract actinium-225 (²²⁵Ac) generated by the natural decay of thorium-229 (²²⁹Th) through an actinium-225 (²²⁵Ac) extraction unit.

The target 121 may further include other radioisotopes other than thorium, for example, impurities of a natural thorium target itself, products generated during the generation of the thorium isotope including one or more among thorium-229 (²²⁹Th) and thorium-230 (²³⁰Th), or products generated by the natural decay of thorium-231 (²³¹Th).

Other radioisotopes other than thorium may include, for example, actinium (Ac), protactinium (Pa), radium (Ra), and the like.

If other radioisotopes other than thorium are not removed, other actinium isotopes, which are decayed and generated from other radioisotopes, may be extracted together other than actinium-225 (²²⁵Ac) during the extraction process of actinium-225 (²²⁵Ac), and thus, it may be difficult to extract actinium-225 (²²⁵Ac) of high purity.

Therefore, the target 121 from which other radioisotopes other than thorium are removed by the separation and recovery unit may include, as thorium isotopes, thorium-232 (²³²Th) and thorium-229 (²²⁹Th), may further include thorium-230 (²³⁰Th), may further include one or more selected from the group consisting of thorium-228 (²²⁸Th), thorium-227 (²²⁷Th), and thorium-226 (²²⁶Th), and more preferably, may or may not include an extremely small amount of thorium-231 (²³¹Th) and actinium isotopes.

The system 100 for producing radioisotopes may further include an actinium-225 (²²⁵Ac) extraction unit for extracting actinium-225 (²²⁵Ac) from the target, and actinium-225 (²²⁵Ac) generated by the decay of thorium-229 (²²⁹Th) may be extracted from the extraction unit.

Meanwhile, in the radioisotopes recovered from the separation and recovery unit, there may be a protactinium (Pa) isotope including protactinium-231 (²³¹Pa) separated from an actinium isotope including actinium-227 (²²⁷Ac), which is a parent nuclide of thorium-227 (²²⁷Th), and from a radium isotope including radium-226 (²²⁶Ra).

Through the above separation process, thorium-230 (²³0Th) generated when protactinium-230 (²³⁰Pa) among the protactinium (Pa) isotopes naturally decays and thorium-227 (²²⁷Th) generated when actinium-227 (²²⁷Ac) naturally decays are physically separated, so that thorium-227 (²²⁷Th) of high purity may be generated therefrom.

Particularly, actinium-227 (²²⁷Ac) may be semi-permanently extracted from protactinium-231 (²³¹Pa) included in the protactinium (Pa) isotopes recovered from the separation and recovery unit.

To this end, the system 100 for producing radioisotopes may extract actinium-227 (²²⁷Ac) from each of the protactinium isotopes and radium (Ra) and actinium (Ac) isotopes, which are separately recovered from the separation and recovery unit, and then naturally decay the extracted actinium-227 (²²⁷Ac) to generate thorium-227 (²²⁷Th).

The system 100 for producing radioisotopes may further include a thorium-227 (²²⁷Th) extraction unit for extracting thorium-227 (²²⁷Th) generated from the separation and recovery unit.

Meanwhile, using the system 100 for producing radioisotopes, a natural thorium target including thorium-232 (²³²Th) may be irradiated with the braking radiation or accelerated electron beam to generate thorium isotopes including thorium-230 (²³⁰Th), radium-226 (²²⁶Ra) naturally decayed from thorium-230 (²³⁰Th) may be generated, or radium-226 (²²⁶Ra) separated and recovered from the target may be included in the separation and recovery unit.

The system 100 for producing radioisotopes may further include a radium-226 (²²⁶Ra) extraction unit for extracting radium-226 (²²⁶Ra) generated from at least one of the target and the separation and recovery unit.

Hereinafter, the present invention will be described in detail through examples and experimental examples.

However, the following examples and experimental examples are only illustrative of the present invention, and the contents of the present invention are not limited by the following examples.

### Example 1

Step 1: A system for producing radioisotopes was designed in the following form.

First, a natural thorium target including thorium-232 (²³²Th) was prepared in a cylindrical shape (radius 100 mm, length 3 cm, mass 11 kg) having a hollow part formed and extending in a longitudinal direction, and shielding and cooling equipment was configured such that all the surfaces of the cylindrical target were shielded and the target were rotatable around the hollow part.

In addition, the shielding and cooling equipment includes a coolant inlet which is connected to a coolant supplying unit and through which a coolant is introduced and a coolant outlet through which the introduced coolant is discharged. Through the above, it was configured that a coolant was circulated inside the shielding and cooling equipment to cool the target and the shielding and cooling equipment. At this time, as a coolant, water was used, which is excellent in heat removal capability and neutron moderation effect for shielding neutrons generated during a photonuclear reaction.

In addition, it was configured that an electron beam having a diameter of a few millimeters and a beam current of 80 mA was to be generated from an accelerated electron beam generator and be directly irradiated on a rotating circular cross-section of the target.

Step 2: Using the accelerated electron beam generator and an irradiation unit, an accelerated electron beam was irradiated for 1 year on the natural thorium target to cause a chain photonuclear reaction to occur.

Step 3: The target was left to stand for 30 days in the shielding and cooling equipment to be cooled. Thereafter, by an ion resin separation method and a solvent extraction method, a protactinium (Pa) isotope and other radium (Ra) and actinium (Ac) isotopes, which are isotopes other than thorium, were separated and removed from the target. Thereafter, with a 20-day extraction period, an actinium isotope was extracted from the target by an ion resin separation method to generate actinium-225 (²²⁵Ac). Actinium-227 (²²⁷Ac) was generated from impurities, and with a 1-day extraction period, thorium-227 (²²⁷Th) was generated.

### Example 2

Actinium-225 (²²⁵Ac) and thorium-227 (²²⁷Th) were generated in the same manner as in Example 1 except that the period during which an actinium isotope is extracted from the target in Step 3 of Example 1 was changed to 90 days instead of 20 days.

### Example 3

Actinium-225 (²²⁵Ac) and thorium-227 (²²⁷Th) were generated in the same manner as in Example 1 except that the irradiation time of the electron beam in Step 2 of Example 1 was changed to 0.5 years.

### Example 4

Actinium-225 (²²⁵Ac) and thorium-227 (²²⁷Th) were generated in the same manner as in Example 1 except that the irradiation time of the electron beam in Step 2 of Example 1 was changed to 3 years.

### Example 5

Actinium-225 (²²⁵Ac) and thorium-227 (²²⁷Th) were generated in the same manner as in Example 1 except that the irradiation time of the electron beam in Step 2 of Example 1 was changed to 5 years.

### Example 6

Actinium-225 (²²⁵Ac) and thorium-227 (²²⁷Th) were generated in the same manner as in Example 1 except that the irradiation time of the electron beam in Step 2 of Example 1 was changed to 5 years, and the period during which an actinium isotope is extracted from the target in Step 3 thereof was changed to 90 days instead of 20 days.

### <Experimental Example 1> Change in Number Density of Radioisotopes in Target Over Time

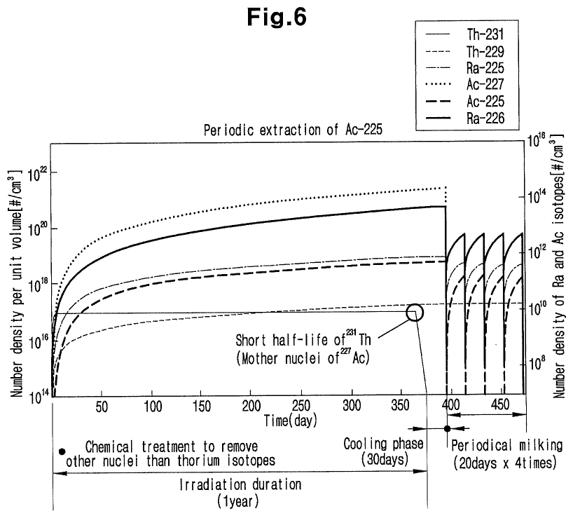

In Example 1, the number density of radioisotopes included in the target over time was calculated and is shown in FIG. 6.

As shown in FIG. 6, it can be seen that the number density of thorium-231 (²³¹Th) among thorium isotopes included in the target was rapidly decreased during a cooling process due to a short half-life of 25 hours. In addition, actinium-225 (²²⁵Ac) and actinium-227 (²²⁷Ac), which were actinium isotopes either included in the target or generated during the photonuclear reaction process, were removed through a chemical separation process for removing radioisotopes other than the thorium isotopes after the 30-day cooling, and thus, it can be seen that the number density thereof was rapidly decreased. In addition, it can be seen that the number density of actinium-225 (²²⁵Ac) was increased for 90 days after the chemical separation process, while the number density of actinium-227 (²²⁷Ac) was not increased.

Since thorium-231 (²³¹Th), which is a parent nuclide of actinium-227 (²²⁷Ac), was removed through the cooling process, and then actinium isotopes were removed during the chemical separation process thereafter, it can be seen that, in the following actinium isotope extraction step, only actinium-225 (²²⁵Ac), which was generated by the decay of thorium-229 (²²⁹Th), was extracted. Therefore, it can be seen that a method for producing actinium-225 (²²⁵Ac) according to one aspect has an advantage in that actinium-227 (²²⁷Ac), which is difficult to chemically separate, is not extracted together when actinium-225 (²²⁵Ac) is extracted, or actinium-227 (²²⁷Ac) is extracted together but in an extremely small amount. Radium-226 (²²⁶Ra), which is included in remaining radium isotopes after the extraction of actinium-225 (²²⁵Ac) is an isotope produced in less than 1 g per year, and is continuously accumulated as the extraction of actinium-225 (²²⁵Ac) is repeated, so that it may be extracted and utilized when there is demand.

### <Experimental Example 2> Change in Number Density of Radioisotopes in Impurities Over Time

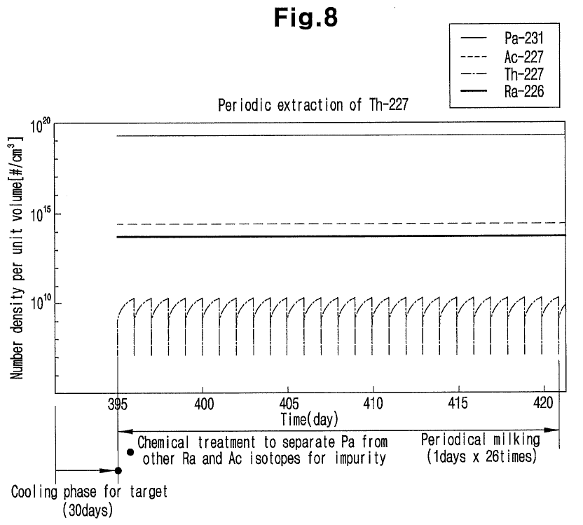

After the primary cooling of the target and then the separation of the target and impurities through chemical treatment in Example 1, the number density of radioisotopes included in the impurities over time was calculated and is shown in FIG. 8.

As shown in FIG. 8, in a process of removing other isotopes other than thorium from a target, when radium and actinium isotopes are separated from a protactinium isotope, the only thorium isotope generated by the natural decay in the radium and actinium isotopes is thorium-227 (²²⁷Th). In addition, the only actinium isotope generated by the natural decay in the protactinium isotope is actinium-227 (²²⁷Ac), which is a parent nuclide of thorium-227 (²²⁷Th), and it may be semi-permanently generated from protactinium-231 (²³¹Pa). Therefore, in the present method for producing thorium-227 (²²⁷Th), actinium-227 (²²⁷Ac), which is a parent nuclide of thorium-227 (²²⁷Th), is continuously supplied from the protactinium isotope to repeatedly extract thorium-227 (²²⁷Th) from the separated radium and actinium isotopes.

Through the above production method, thorium-227 (²²⁷Th) is the only thorium isotope present in the radium and actinium isotopes, and thorium-230 (²³⁰Th), which is generated when protactinium-230 (²³⁰Pa) naturally decays, may be excluded. Therefore, it can be seen that the method for producing thorium-227 (²²⁷Th) according to one aspect has an advantage in that thorium-230 (²³⁰Th), which is difficult to chemically separate, is not extracted together when thorium-227 (²²⁷Th) is extracted, or thorium-230 (²³⁰Th) is extracted together but in an extremely small amount. In addition, the amount of actinium-227 (²²⁷Ac), which is a parent nuclide of thorium-227 (²²⁷Th), continuously increases, and thus, the amount of thorium-227 (²²⁷Th) per a single extraction also increases. Therefore, the advantage of the above production method is maximized and the extraction is performed for a long period of time. In addition, as described above, radium-226 (²²⁶Ra), which is included in remaining radium isotopes after the extraction of thorium-227 (²²⁷Th), may be extracted and utilized when there is demand.

### <Experimental Example 3> Comparison of One-Time Extraction Volume of Actinium-225 (²²⁵Ac)

One-time extraction volume of actinium-225 (²²⁵Ac) according to conditions of a method for producing actinium-225 (²²⁵Ac) according to one aspect and the same according to conditions of a typical accelerator-based method for producing actinium-225 (²²⁵Ac) were compared and are shown in Table 1 below.

TABLE 1

| | Comparative | | Comparative | | Comparative | | Comparative | | | | | |
|---|---|---|---|---|---|---|---|---|---|---|---|---|
| | Example 1 | | Example 2 | | Example 3 | | Example 4 | | Example 1 | | Example 2 | |
| Accelerator | Proton | | Proton | | Electron | | Electron | | Electron | | Electron | |
| facility | Accelerator | | accelerator | | beam | | beam | | beam | | beam | |
| | | | | | Accelerator | | Accelerator | | Accelerator | | Accelerator | |
| Nuclear | ²²⁶Ra(p,2n)²²⁵Ac | | ²²⁶Ra(p,2n)²²⁵Ac | | ²²⁶Ra(g,n)²²⁵Ra | | ²²⁶Ra(g,n)²²⁵Ra | | Chain | | Chain | |
| reaction | | | | | | | | | photonuclear | | photonuclear | |
| | | | | | | | | | reaction | | reaction | |
| Target mass | 30 | mg | 210 | mg | 40 | mg | 40 mg × 63 | | 11 | kg | 11 | kg |
| Beam current | 50 | μA | 500 | μA | 26 | μA | 26 | μA | 80 | mA | 80 | mA |
| Irradiation | 45.3 | hours | 1 | hour | 2.9 | hours | 2.9 | hours | 1 | year | 1 | year |
| time | | | | | | | | | | | | |
| Extraction | 1 | day | 1 | day | 18 | days | 18 | days | 90 | days | 20 | days |
| period | | | | | | | | | | | | |
| One-time | 13.1 | mCi | 20.1 | mCi | 29 | μCi | 1.83 | mCi | 10.2 | mCi | 3.31 | mCi |
| extraction | | | | | | | | | | | | |
| volume of | | | | | | | | | | | | |
| ²²⁵Ac | | | | | | | | | | | | |

(In Table 1 above, Comparative Example 2 is a calculation result under conditions in which the current of proton beam and the shape of a target were optimized based on an actual experimental result of Comparative Example 1, and Comparative Example 4 is a calculation result under optimized conditions in which the number of targets was increased based on an actual experimental result of Comparative Example 3. In addition, in a production method using a proton accelerator, actinium-225 (²²⁵Ac) is immediately produced upon irradiation by a nuclear reaction, but since it requires a minimum time to extract from a target, the extraction period was assumed to be 1 day.)

As shown in Table 1 above, in the method for producing actinium-225 (²²⁵Ac) according to one aspect, the amount of actinium-225 (²²⁵Ac) generated per unit beam irradiation time is smaller than that of other methods (Comparative Examples 1 to 4). However, the method has a remarkably excellent advantage in that, after a year of irradiation, actinium-225 (²²⁵Ac) may be semi-permanently extracted from thorium-229 (²²⁹Th) whenever necessary without additional beam irradiation.

In addition, the method for producing radioisotopes according to one aspect has a remarkably excellent advantage in terms of economic production, when considering that the operating cost is much higher when using a proton accelerator than when using an electron beam accelerator (Comparative Examples 1 and 2).

In addition, the method for producing radioisotopes according to one aspect is more advantageous in that it is safer to use and has a larger one-time extraction volume of actinium-225 (²²⁵Ac) than a case (Comparative Examples 3 and 4) in which a typical electron beam accelerator was used but a radium target, which is difficult to prepare and handle, was used.

### <Experimental Example 4> Production Volume of Actinium-225 (²²⁵Ac) According to Beam Irradiation Time and Extraction Period, and the Number of Annual Doses

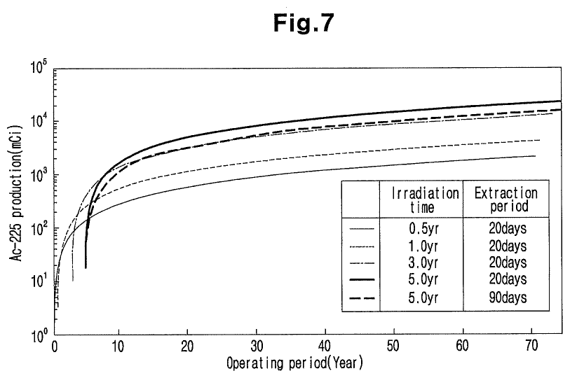

In the method for producing radioisotopes according to one aspect, the production volume of actinium-225 (²²⁵Ac) according to beam irradiation time and extraction period, and the number of annual doses in accordance therewith were calculated and are shown in FIG. 7 and Table 2 below.

TABLE 2

| | Example 3 | | Example 1 | | Example 4 | | Example 5 | | Example 6 | |
|---|---|---|---|---|---|---|---|---|---|---|
| Irradiation | 0.5 | years | 1 | year | 3 | years | 5 | years | 5 | years |
| time | | | | | | | | | | |
| Extraction | 20 | days | 20 | days | 20 | days | 20 | days | 90 | days |
| period | | | | | | | | | | |

| | | | | | |
|---|---|---|---|---|---|
| Number of | 294 | 594 | 1,862 | 3,235 | 2,215 |
| doses per | | | | | |
| year | | | | | |

FIG. 7 and Table 2 above shows the production volume of actinium-225 (²²⁵Ac) according to electron beam irradiation time and extraction period, and the number of annual doses in accordance therewith in the method for producing radioisotopes according to one aspect.

At this time, the horizontal axis (operating time) of FIG. 7 represents the total elapsed time from the beam irradiation to periodic extraction of actinium-225 (²²⁵Ac), and the vertical axis (Ac-225 production) represents the production volume of actinium-225 (²²⁵Ac) generated from the target. The number of doses in Table 2 was calculated based on 0.1 mCi, which is a one-time dose for an adult who weighs 70 kg.

As shown in FIG. 7 and Table 2 above, it can be seen that as the irradiation period of the natural thorium target increases for the same current, the production volume per unit extraction and the number of doses increases linearly in proportional thereto. If the beam current value of the electron beam is set to a larger value, the same amount of actinium-225 (²²⁵Ac) may be produced in a shorter period of time, and conversely, if the beam current value thereof is set to be smaller, it is expected that the desired amount may be obtained by increasing the irradiation period.

In addition, referring to FIG. 7, looking at the production volume of actinium-225 (²²⁵Ac) according to the change in the extraction period when the beam was irradiated for the same time, the production volume for the 20-day extraction period was 46% higher than the production volume for the 90-day extraction period. Through the above, it can be seen that the extraction period of actinium-225 (²²⁵Ac) is more preferable to be 20 days to 40 days in the method for producing actinium-225 (²²⁵Ac) according to one aspect.

### <Experimental Example 5> Production Volume of Thorium-227 (²²⁷Th) Based on 1-Day Extraction Period According to Beam Irradiation Time, and the Number of Annual Doses

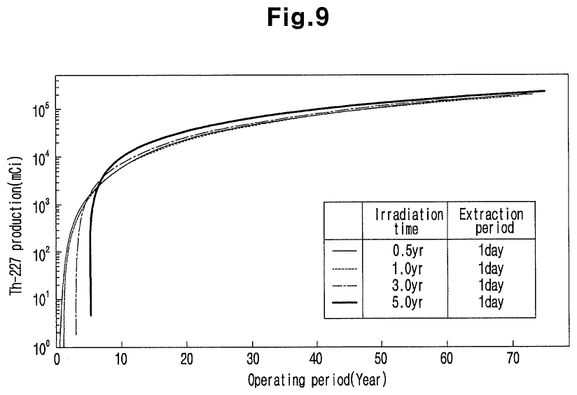

In the method for producing radioisotopes according to one aspect, the production volume of thorium-227 (²²⁷Th) according to beam irradiation time and extraction period, and the number of annual doses in the first year in accordance therewith were calculated and are shown in FIG. 9 and Table 3 below.

TABLE 3

| | Example 3 | Example 1 | Example 4 | Example 5 |
|---|---|---|---|---|
| Irradiation | 0.5 years | 1 year | 3 years | 5 years |
| time | | | | |
| Number of | 935 | 1,520 | 7,255 | 18,158 |
| doses per | | | | |
| year | | | | |

(In Table 3 above, the shorter the extraction period of thorium-227 (²²⁷Th), the larger the production volume thereof. However, since it requires a minimum time to extract from radium and actinium isotopes, the extraction period was assumed to be 1 day.)

FIG. 9 and Table 3 above shows the production volume of thorium-227 (²²⁷Th) according to electron beam irradiation time and extraction period, and the number of annual doses in accordance therewith in the method for producing radioisotopes according to one aspect.

At this time, the horizontal axis (operating time) of FIG. 9 represents the total elapsed time from the beam irradiation to periodic extraction of thorium-227 (²²⁷Th), and the vertical axis (Th-227 production) represents the production volume of thorium-227 (²²⁷Th) generated from the target. The number of doses in Table 2 was calculated based on 0.1 mCi, which is a one-time dose of for an adult who weighs 70 kg.

As shown in FIG. 9 and Table 3 above, it can be seen that as the irradiation period of the natural thorium target increases for the same current, the production volume per unit extraction and the number of doses increases exponentially in proportional thereto, unlike in the case of actinium-225 (²²⁵Ac) in Table 2. This is because, as described above, actinium-227 (²²⁷Ac), which is a parent nuclide of thorium-227 (²²⁷Th), increases linearly over time. If the beam current value of the electron beam is set to a larger value, the same amount of thorium-227 (²²⁷Th) may be produced in a shorter period of time, and conversely, if the beam current value thereof is set to be smaller, it is expected that the desired amount may be obtained by increasing the irradiation period.

In addition, referring to FIG. 9 and Table 3 above, when a beam is irradiated for the same amount of time, the amount of thorium-227 (²²7Th) per a single extraction continues to increase over time, and annual production volume is also larger. As an example, in Example 5, the number of annual doses according to the production volume of actinium-225 (²²⁵Ac) is about 5.6 times larger than the number of annual doses according to the production volume of thorium-227 (²²⁷Th). That is, the method for producing thorium-227 (²²⁷Th) according to one aspect has a remarkably excellent advantage in terms of economic production compared to the method for producing actinium-225 (²²⁵Ac) according to one aspect.

A method for producing radioisotopes according to an aspect is a method for generating one or more among actinium-225 (²²⁵Ac), thorium-227 (²²⁷Th), and radium-226 (²²⁶Ra) from thorium-229 (²²⁹Th) generated by irradiating a natural thorium target with braking radiation, and has an advantage in that the method may be easily used in many countries.

The method is advantageous in that actinium-225 (²²⁵Ac) may be produced semi-permanently whenever necessary without additional beam radiation when producing actinium-225 (²²⁵Ac) from thorium-229 (²²⁹Th).

In addition, since actinium-227 (²²⁷Ac) is generated from a radioisotope separated from a target after the irradiation of braking radiation, thorium-227 (²²⁷Th) may be easily produced therefrom.

In addition, the method may periodically produce radium-226 (²²⁶Ra), which is used in the research to produce medical isotopes with an accelerator from thorium-230 (²³⁰Th), or generate the same through chemical treatment during an extraction process of actinium-227 (²²⁷Ac). Radium-226 (²²⁶Ra) produced therefrom may be used for generating medical isotopes such as thorium-227 (²²⁷Th) or actinium-225 (²²⁵Ac).

In addition, the method for producing radioisotopes uses a natural thorium target, which has lower radioactivity than a radium target and which is easy to manufacture and handle, and uses an electron beam accelerator whose operation cost is lower than that of a proton accelerator. Therefore, not only that actinium-225 (²²⁵Ac) and thorium-227 (²²⁷Th) may be stably produced at a lower price than before and supplied to the market, but also that actinium-225 (²²⁵Ac) and thorium-227 (²²⁷Th) may be easily produced in countries who cannot handle giant accelerators or radium targets. As a result, it is expected that clinical research on targeted alpha therapies will be active and more people will benefit from the therapies.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for producing radioisotopes, comprising:
generating one or more among actinium-225 (²²⁵Ac), thorium-227 (²²⁷Th), and radium-226 (²²⁶Ra) by irradiating a natural thorium target including thorium-232 (²³²Th) with a braking radiation or an accelerated electron beam.

2. The method according to claim 1, wherein the generating one or more among actinium-225 (²²⁵Ac), thorium-227 (²²⁷Th), and radium-226 (²²⁶Ra) comprises generating actinium-225 (²²⁵Ac), wherein the generating of actinium-225 (²²⁵Ac) comprises:
generating thorium isotopes including thorium-229 (²²⁹Th) by irradiating the natural thorium target including thorium-232 (²³²Th) with the braking radiation or accelerated electron beam; and
generating actinium-225 (²²⁵Ac) by the decay of the thorium-229 (²²⁹Th).

3. The method according to claim 2, further comprising, after the generating of the thorium isotope, subjecting the target to primary cooling to naturally decay and remove thorium-231 (²³¹Th) included in the thorium isotope.

4. The method according to claim 3, wherein the primary cooling is performed for 10 days to 50 days.

5. The method according to claim 3, further comprising, distinguishing and separating a protactinium (Pa) isotope from other radium (Ra) and actinium (Ac) isotopes among radioisotopes except for the thorium isotope from the primarily cooled target.

6. The method according to claim 2, wherein the thorium isotope further comprises thorium-230 (²³⁰Th).

7. The method according to claim 1, wherein the generating of one or more among actinium-225 (²²⁵Ac), thorium-227 (²²⁷Th), and radium-226 (²²⁶Ra) comprises generating thorium-227 (²²⁷Th), wherein the generating of thorium-227 (²²⁷Th) comprises:
generating thorium isotopes by irradiating the natural thorium target including thorium-232 (²³²Th) with the braking radiation or accelerated electron beam,
distinguishing and separating a protactinium (Pa) isotope from other radium (Ra) and actinium (Ac) isotopes among radioisotopes except for the thorium isotope from the target;
extracting actinium-227 (²²⁷Ac) from each of the protactinium (Pa) radioisotope and the other radium (Ra) and actinium (Ac) radioisotopes, which have been distinguished and separated from the target; and
generating thorium-227 (²²⁷Th) by natural decay of actinium-227 (²²⁷Ac).

8. The method according to claim 7, wherein the thorium isotope comprises one or more among thorium-229 (²²⁹Th) and thorium-230 (²³⁰Th).

9. The method according to claim 1, wherein the generating of one or more among actinium-225 (²²⁵Ac), thorium-227 (²²⁷Th), and radium-226 (²²⁶Ra) comprises generating radium-226 (²²⁶Ra), wherein the generating of radium-226 (²²⁶Ra) comprises:
generating thorium isotopes including thorium-230 (²³⁰Th) by irradiating the natural thorium target including thorium-232 (²³²Th) with the braking radiation or the accelerated electron beam; and
generating radium-226 (²²⁶Ra) by the decay of the thorium-230 (²³⁰Th).

10. The method according to claim 1, wherein the generating of one or more among actinium-225 (²²⁵Ac), thorium-227 (²²⁷Th), and radium-226 (²²⁶Ra) comprises generating radium-226 (²²⁶Ra), wherein the generating of radium-226 (²²⁶Ra) comprises:
generating thorium isotopes by irradiating the natural thorium target including thorium-232 (²³²Th) with the braking radiation or an accelerated electron beam;
distinguishing and separating a protactinium (Pa) isotope from other radium (Ra) and actinium (Ac) isotopes among radioisotopes except for the thorium isotope from the target; and
generating radium-226 (²²⁶Ra) from the radium (Ra) and actinium (Ac) isotopes separated from the target.

11. A system for producing radioisotopes which generates one or more among actinium-225 (²²⁵Ac), thorium-227 (²²⁷Th), and radium-226 (²²⁶Ra), comprising:
a generation unit for generating a braking radiation or accelerated electron beam; and
an irradiation unit for irradiating a natural thorium target including thorium-232 (²³²Th) with braking radiation or an accelerated electron beam generated from the generation unit.

12. The system according to claim 11, wherein the irradiation unit comprises:
a natural thorium target including thorium-232 (²³²Th); and
shielding and cooling equipment receiving the natural thorium target, and cooling and shielding the natural thorium target.

13. The system according to claim 11, wherein the natural thorium target is rotatavely received in the shielding and cooling equipment.

14. The system according to claim 11, further comprising, a separation and recovery unit for distinguishing and then separating and recovering a protactinium (Pa) isotope from other radium (Ra) and actinium (Ac) isotopes among radioisotopes except for thorium isotopes from the target.

15. The system according to claim 11, further comprising, an actinium-225 (²²⁵Ac) extraction unit for extracting actinium-225 (²²⁵Ac) from the target.

16. The system claim 14, further comprising, a thorium-227 (²²⁷Th) extraction unit for extracting thorium-227 (²²⁷Th) from the separation and recovery unit.

17. The system according to claim 14, further comprising, a radium-226 (²²⁶Ra) extraction unit for extracting radium-226 (²²⁶Ra) from at least one of the target and the separation and recovery unit.
